(19) United States
(12) Patent Application Publication
(10) Pub. No.: US 2014/0150116 A1
(43) Pub. Date: May 29, 2014

(54) CONTROLLING RELEASE OF SECURE DATA

(71) Applicant: INTERCEDE LIMITED, Lutterworth (GB)

(72) Inventor: Christopher Paul Edwards, Nottingham (GB)

(73) Assignee: INTERCEDE LIMITED, Lutterworth (GB)

(21) Appl. No.: 14/076,397

(22) Filed: Nov. 11, 2013

(30) Foreign Application Priority Data
Nov. 23, 2012 (GB) 1221146.2

(51) Int. Cl. G06F 21/62

(52) U.S. Cl. CPC G06F 21/62
USPC 726/28

(57) ABSTRACT

Controlling release of secure data is described. In an embodiment data verified by a trusted authority and other personal data may be stored in a data store on a mobile device. In an example the data store may be secured cryptographically. In an example the data store may be encrypted using one or more encryption keys. In response to receiving a request from a requesting application one or more of the data items may be provided to the requesting party to verify an aspect of a user's identity. In an example, in response to receiving a request from a requesting application user input may be requested, the user input specifying whether or not the data item may be released. In an example, the data store may be provided with a certificate, which may be revoked to prevent access to the stored data items.

### BACKGROUND

People are regularly asked to prove some aspect of their identity, for example, to access premises or services, or to receive a benefit or a discount. Traditionally, this has entailed the use of membership cards or identity cards. Identity cards may be simple paper or plastic cards or more secure electronic smart cards or tokens. In an example where an identity card is an officially issued document, if it is lost, it may be time consuming and difficult to replace.

Many of the documents which may prove a user's identity to enable them to access a service or obtain a product include far more information than a requesting party may actually need. Revealing this information to a requesting party may be a security risk which puts a user at risk of identity theft.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Controlling release of secure data is described. In an embodiment data verified by a trusted authority and other personal data may be stored in a data store on a mobile device. In an example the data store may be secured cryptographically. In an example the data store may be encrypted using one or more encryption keys. In response to receiving a request from a requesting application one or more of the data items may be provided to the requesting party to verify an aspect of a user's identity. In an example, in response to receiving a request from a requesting application user input may be requested, the user input specifying whether or not the data item may be released. In an example, the data store may be provided with a certificate, which may be revoked to prevent access to the stored data items.

A first aspect provides a method for controlling access to secured data comprising: receiving a request to release one or more data items to a requesting party; receiving one or more user inputs specifying if the one or more requested data items can be released; and if the received user input specifies that the one or more data items can be released, releasing the one or more data items to the requesting party.

A second aspect provides a mobile device arranged to control access to secured data, the mobile device comprising: requesting means which, in response to receiving a request from a requesting party to release data and one or more user inputs specifying which data is to be released, retrieves the secured data from the secure data store and supplies the requested secured data to the requesting party.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of requesting secure data release;

FIG. 2 is a schematic diagram of a system for controlling the release of secure data;

FIG. 3 is a flow diagram of an example method for controlling the release of secure data using the system described with reference to FIG. 2;

FIG. 4 is a flow diagram of an example method of obtaining trusted data on demand;

FIG. 5 is a flow diagram of an example method of checking access credentials for trusted data;

FIG. 6 is a schematic diagram which illustrates various components of an example computing-based device which may implement a method of controlling secure data release.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

The all or nothing nature of identity cards makes revealing information potentially problematic. In an example, when a person is required to prove their age for the purposes of buying alcohol, it may be necessary to present a passport or driving license to a cashier. This may reveal unnecessarily the persons full name, date of birth and address when all that is required is proof that the person is of legal age. However, using a smart-phone, tablet or other mobile device and the methods described herein, a user may instead be able to reveal only the information that is required to satisfy a specific identity check.

In addition, users of mobile devices may have many different accounts for different applications and may be required to input information repeatedly each time a different application is accessed. There is therefore a need to keep this information securely in a common or shared store such that it can be accessed quickly and with minimal input from the user.

Described herein are examples of software and hardware components that together may allow for the secure storage and selective exposure of personal attributes and credentials to a requesting party. The examples described herein are based on storing one or more “credentials”. A credential is defined as electronic verified proof of association of an attribute, for example name, age, credit card details, membership number, with a person. In an example, a credential supplied to a requesting party may present to a requesting party a picture of a user (so that they can be identified if present in person) and their age. The credential may be signed by a trusted third party such as a passport authority so that the requesting party knows the information can be trusted. However, the system and methods described below may be applicable to any type of data that a user may wish to keep secure and release selectively to other parties.

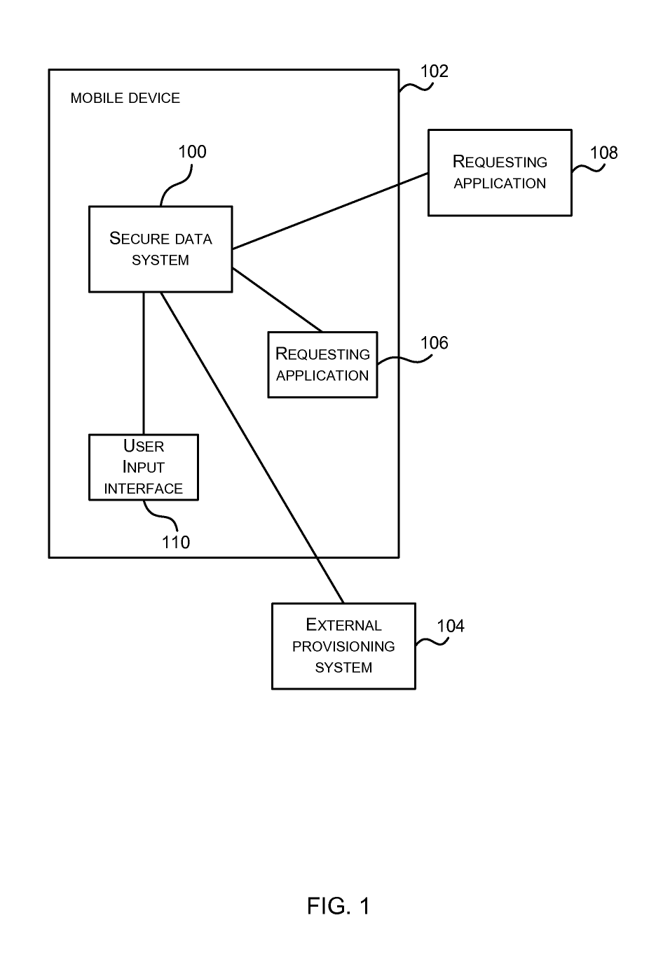

FIG. 1 is a schematic diagram of a system for requesting secure data release. In an embodiment a secure data system 100 is implemented at a mobile device 102. The secure data system 100 may be arranged to store data.

The secure data system 100 may be provisioned with data from an external provisioning system 104. For example, the external provisioning system 104 may provision the secure data system with one or more credentials. In an embodiment a credential may be represented by a piece of data signed and certificated by a trusted authority and retained locally. The particular trusted authority which signs the piece of data may depend on what data the credential contains. For example, the credential may verify the user's name, age or date of birth, in which case the credential may be signed by a government authority e.g. a passport issuing authority. In another example the credential may verify a user's professional qualifications, in which case it may be signed by a professional body. In other examples the credential may store information such as a user's golf handicap, sports club membership number or other personal information in which case it may be signed by the appropriate body.

A request may be received from a requesting application 106, 108. The requesting application may be an application which is running within the operating environment of the mobile device 102 e.g. if a user wishes to make a purchase at an online shop via a web browser running on mobile device 102 then they may have to supply personal information such as name, address and credit card number to the online shop in order to complete the purchase. In this example, the web browser is the requesting application. Alternatively, the purchase may be made via an application (or ‘app’) associated with the online shop and running on the mobile device 102 and in this example, the application is the requesting application. In another example the requesting application may be running externally to the mobile device, for example the requesting application may run on a terminal in a shop where the user wishes to make a purchase and may communicate with the secure data system 100 via a wireless link, for example using WiFi, NFC, Bluetooth™ or other appropriate link.

In response to the request from the requesting application 106, 108 the secure data system 100 may request user input via a user input interface 110 to determine which data (if any) to release to the requesting application.

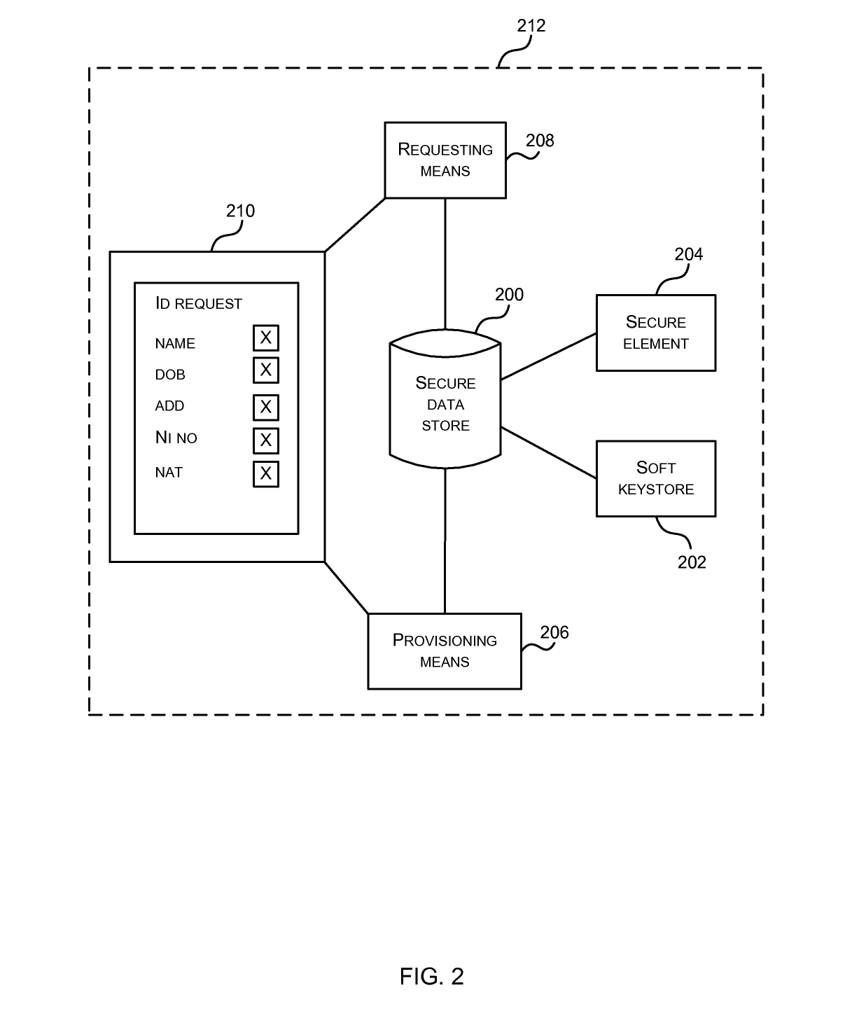

FIG. 2 is a schematic diagram of a system for controlling the release of secure data. In an example the system may be implemented on a mobile device as described with reference to FIG. 1 (e.g. system 100). In an example the system comprises a secure data store 200 in which data is stored. In an example the data stored may be secured by cryptographically encrypting the data in addition, or instead, the entire data store may be secured through use of a password or other access control mechanism (e.g. PIN, biometrics, etc). Where the data items in the store are encrypted, the data items may be referred to as secure data items.

The secure data store may be secured using asymmetric key encryption; however other types of encryption, for example symmetric key encryption, may be used. The encryption keys may be stored in soft form, for example in a software keystore 202, or may be held in a secure hardware element 204, for example a subscriber identity module, flash memory card or other embedded or external secure element. The software keystore 202 may be implemented in general persistent memory rather than a specific hardware element.

In an example, the secure data items stored in the data store may be encrypted with one or more of different kinds of secure keys. Some data items, for example root identity data, may be stored using an asymmetric key encryption. Asymmetric key encryption is useful for encrypting small amounts of data and has the advantage that the public key can be shared. However asymmetric key encryption can be relatively slow. Various data items in the data store may therefore be encrypted using symmetric encryption, which enables high volumes of data to be encrypted quickly.

The secure data store 200 may be provisioned with data, for example one or more credentials, via a provisioning means 206. Provisioning means 206 may receive data, for example one or more credentials, from one or more trusted provisioning services, for example, a provisioning service provided by a government department or other trusted provisioning authority. In an example the one or more data items may be delivered over a secure channel between the provisioning service and the mobile device. For example the channel may be encrypted using secure key encryption and the keys used may be negotiated between the two entities (e.g. the provisioning service and the mobile device) prior to the transfer of data.

A requesting means 208 may act as an interface between the secure data store 200 and a requesting application, for example one of the requesting applications 106, 108 described with reference to FIG. 1. The requesting means may receive a request from a requesting application for one or more secure data items and in response to that request present a plurality of options to a user via a user interface 210 to enable the user to specify which data (if any) should be released.

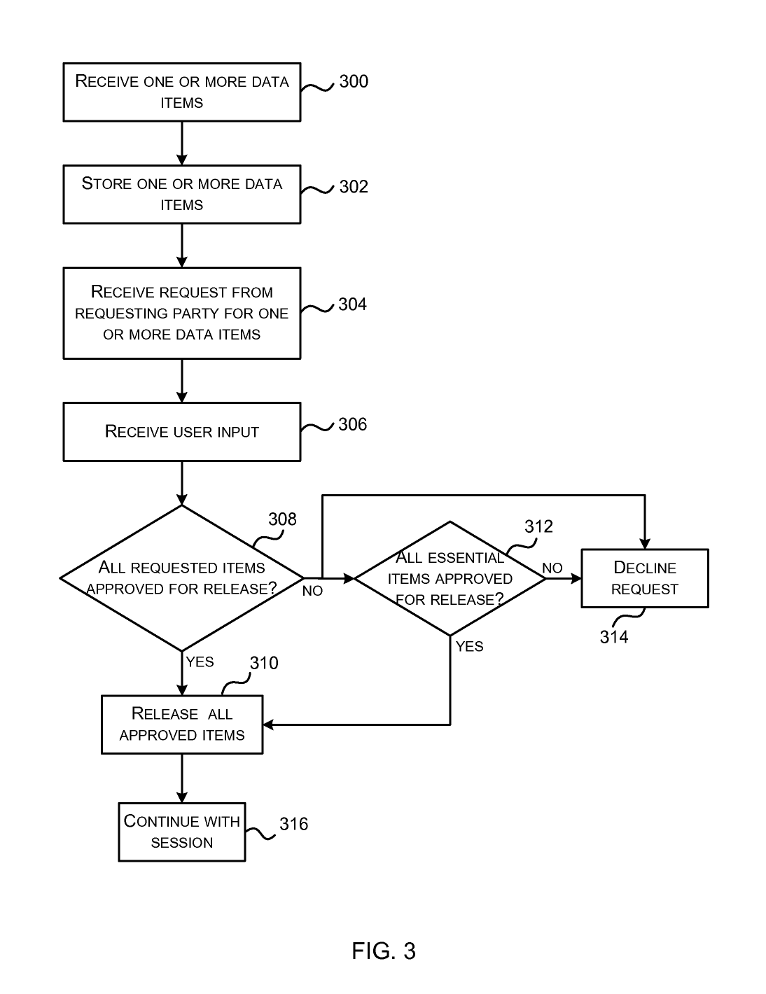

FIG. 3 is a flow diagram of an example method for controlling the release of secure data using the system described with reference to FIG. 2. In an example one or more data items are received (block 300) at a secure data store which may be implemented in a mobile device. Data items may be received from a trusted provider or any other source. The received data may then be stored (block 302) in the secure data store for later retrieval. In an example, the user of the mobile device may wish to store data items relating to one or more applications or accounts within the secure data store. The data stored may relate to one or more virtual identities or profiles. For example, a first virtual identity may be a “home” profile which may be arranged to share one or more credentials e.g. a home address, and a second virtual identity may be a “work” profile which may be arranged to share one or more different credentials e.g. a work address.

A request may be received (block 304) from a requesting party. In an example the requesting party may be an application running on the mobile device e.g. an online shopping application running via a browser or other application running on a mobile device. In another example, the requesting party may be an application external to the mobile device, e.g. the application may be running on a terminal of another user (for example a cashier in a shop). The remote terminal may communicate with the mobile device via NFC or other short range wireless communication and an application executing on the mobile device (for example an NFC reader) may act as a proxy application. For example, in order to carry out an age check the user may touch their phone to an NFC terminal of another party and a data item may be transferred from the secure data store, via the NFC application on the mobile device, to the terminal confirming the age of the user.

The identity requesting means may initially ask the user to verify their identity, for example, by entering a Personal Identification Number (PIN) or password or using another method of identification such as biometrics (e.g. a finger print or iris scan) and then request user input as to which data items to release in response to the request from the requesting application.

The requesting application may request a single data item or a plurality of different data items from the requesting means. In an example, the items requested may be presented as a list at the user interface. User input may be received (block 306) confirming whether or not release any of all of the data items to the requesting party should be enabled.

The user may be able to confirm (via the user input received in block 308) whether an item should be released and/or refuse permission for the item to be released. In an example a user may be able to confirm or refuse release of information by checking or un-checking a check box next to each item (or an identifier associated with each item, e.g. the list may state ‘Date of Birth’ rather than displaying the user's actual date of birth to increase security). If the user confirms that a data item should be released then the item may be released (block 310) to the requesting party. If the user declines permission to release an item then the request may be declined (block 314, with block 312 omitted in this example).

In an example the user may not be required (by the requesting application) to release all requested items. For example, the user may be presented with an indication whether a piece of information is essential for access to the service they are requesting. For example, a user may be attempting to purchase alcohol via the internet. An online store application may request that the user confirm their name, address, age and date of birth in order to complete the purchase. However, for the purpose of purchase and delivery only the user's name, address and age may be indicated (by the online store application as requesting application) as being essential. Therefore the user may refuse the requesting means permission to release their date of birth without this resulting in the transaction being aborted. In an example the system may determine if a user has released all essential information (block 312 and in some examples, block 308 may be omitted). If an essential piece of information is not released then the session may be terminated and the request declined (block 314), however, if all the essential information has been supplied but some optional information is refused, the approved items are released (block 310) and the session may proceed (block 316).

The secure data system may remember which data items a user has previously authorised a requesting party to receive (e.g. by tagging the data item with this information). For example, a user may specify that an online store can be supplied with a user's credit card details. The user may also be able to specify that these items may be supplied to the same store in future without further user authorisation. Therefore, the next time a user makes a purchase at the same online store the requested details may be supplied automatically without any input from the user (e.g. block 306 is omitted). In an example the user may be able to specify that these items should be supplied indefinitely or for a specified period of time. In an example a user may be able specify which data items can be supplied automatically each time they are requested and which data items need permission from the user e.g. a user may specify that anyone can be supplied with a confirmation of age but permission is needed to supply a confirmation of date of birth.

In an embodiment the system may derive data items from stored credentials. For example, an authenticated credential specifying the user's date of birth may be stored at the data store and from this credential the user's age may be derived. The certificate applied to the date of birth credential may additionally be applied to the user's age, alternatively a new certificate may be issued updating the credential on a regular basis e.g. annually or at a specified milestone, for example each year on the user's birthday, or when the user reaches a significant age (e.g. 18 or 21).

In an example the system described with reference to FIG. 2 and method described with reference to FIG. 3 may be implemented within a trusted execution environment (TEE) 212. A TEE is a secure area that resides in the main processor of a mobile device and ensures that sensitive data is stored, processed and protected in a trusted environment. The TEE isolates access to its hardware and software to only trusted applications. The TEE may provide a secure mode of operation for keyboard and screen and may provide visual confirmation that data entry and display are being performed uniquely by a trusted application. For example, this may ensure that typing into a keyboard that is presented by an application at a display is safe, in particular, this may be used to prevent so-called “man in the browser” attacks.

The request made by a requesting party (and received in block 304) may be for a piece of information which is stored in the data store or for a piece of information which is not presently stored at the data store. Where the information is not already stored locally the system may be able create new data items on demand through access to a trusted authority.

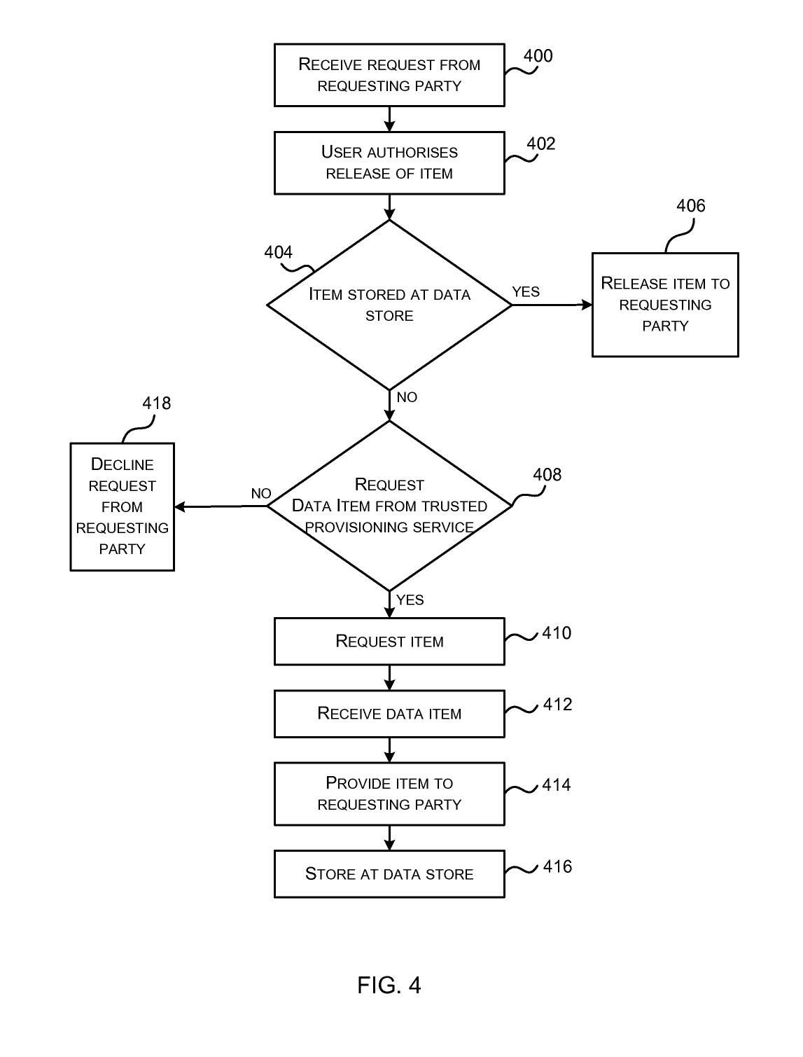

FIG. 4 is a flow diagram of an example method of obtaining trusted data on demand. In an embodiment a request may be received (block 400) from a requesting party (i.e. a requesting application) for a data item and the user may authorise (block 402) the release of the requested item as described above with reference to FIG. 3. If the data item is stored (block 404) at the secure data store then it may be provided (block 406) to the requesting party. However, if the data item is not stored at the secure data then the user may be presented with an option to request (block 408) the data item from one or more trusted provisioning services. If the user indicates that they want to request the item then the item can be requested (block 410). When the item is received (block 412) from the trusted provisioning service it may then be supplied (block 414) to the requesting party and stored (block 416) in the data store for later use. However, if the user declines the request to obtain the data item from one or more trusted provisioning services the request from the requesting party will be declined (block 418).

In an example the user may be attempting to make a purchase and the requesting party (i.e. the requesting application) requests the user's credit card details. If the user authorises release of the credit card details to the requesting party and they are not stored at the secure data store the user may be presented with a message which states, for example, “request data item from the following trusted provisioning services?” followed by a list of available provisioning services e.g. Visa, MasterCard, American Express. The user may then be able to select which trusted provisioning service to use to obtain the data item from. Alternatively the user may be able to decline, in which case the data item is not requested and the session may be terminated.

In an embodiment a user may wish to ensure that if their mobile device is lost or stolen a third party is unable to gain access to the information stored therein (e.g. the information stored in the secure data store). Therefore in addition to the encryption of the data store and/or PIN or other protection when accessing the device or data store, each time a request is made for access to the data store (by the user of the mobile device or a third party) the system may carry out an additional validity check.

In an example, the system may be initialised with an asymmetric key pair. The asymmetric key pair may be used to obtain a certificate based on the key pair. The certificate may be used to set up a root identity comprising for example name, address etc. The validity of the certificate may be checked every time an attempt is made to access the system (e.g. by checking a certificate revocation list (CRL) issued by the certificate issuing authority).

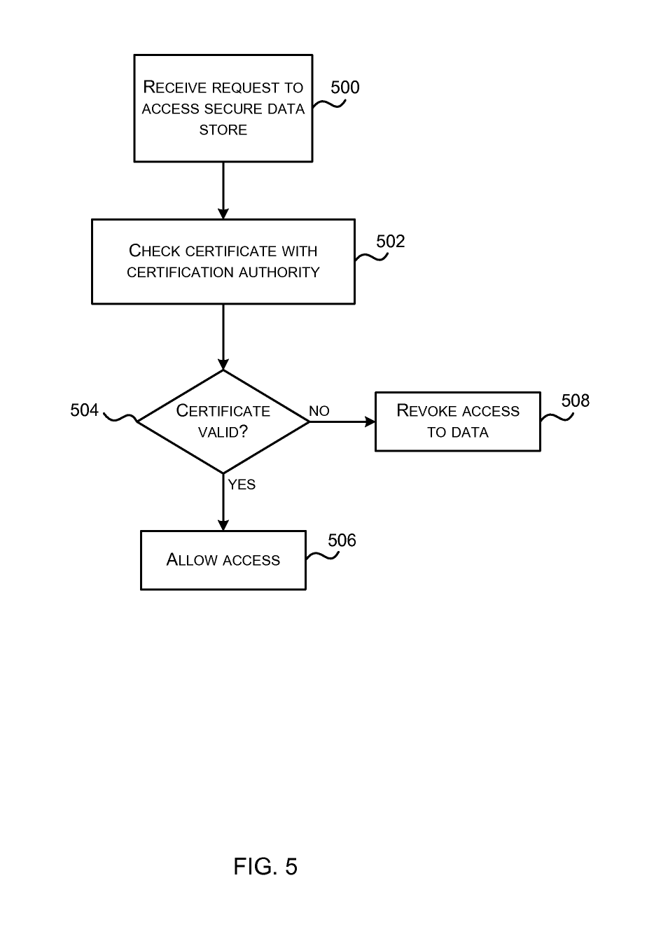

FIG. 5 is a flow diagram of an example method of checking access credentials for trusted data. In an embodiment a request is received to access (block 500) the secure data store. The request may be from a user of the device or another requesting party. On receiving the request the system may check (block 502) a certificate associated with the basic user profile (e.g. by checking a CRL). If the certificate is valid (block 504) then the system allows (block 506) access to the requested information. However, if the certificate is invalid the system may revoke all access to the data. In addition the system may erase all data held at the mobile device to ensure security.

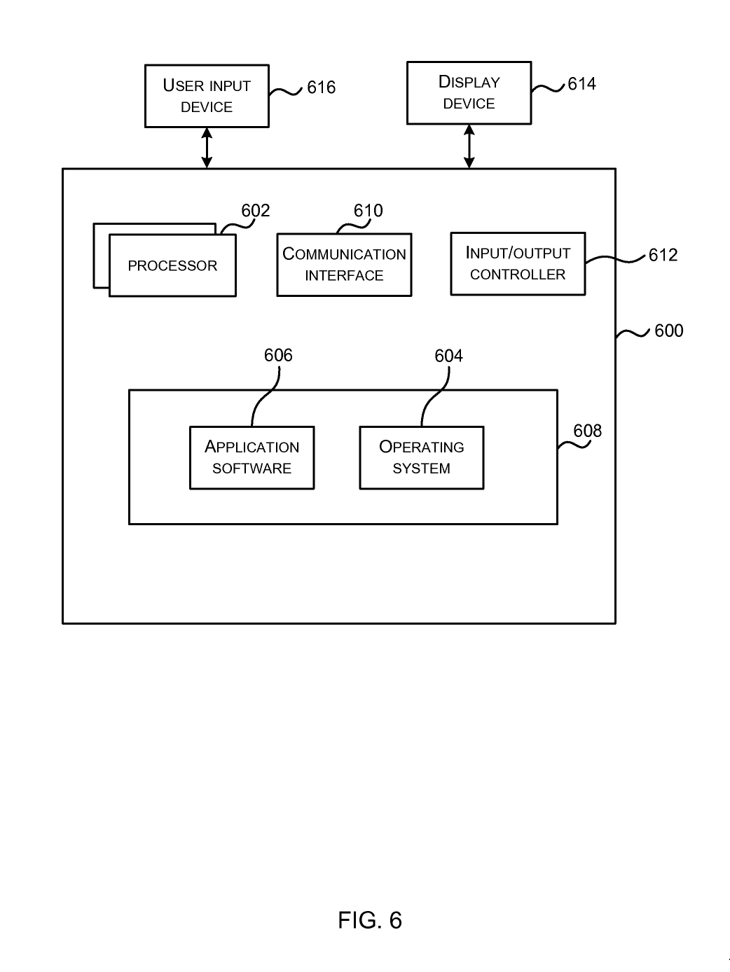

FIG. 6 illustrates various components of an exemplary computing-based device 600 which may be implemented as any form of a computing and/or electronic device, and in which embodiments of a system for controlling release of secure data may be implemented.

Computing-based device 600 comprises one or more processors 602 which may be microprocessors, controllers or any other suitable type of processors for processing computer executable instructions to control the operation of the device in order to control access and release of secure data. In some examples, for example where a system on a chip architecture is used, the processors 602 may include one or more fixed function blocks (also referred to as accelerators) which implement a part of the method of controlling release of secure data in hardware (rather than software or firmware). Platform software comprising an operating system 604 or any other suitable platform software may be provided at the computing-based device to enable application software 606 to be executed on the device.

The computer executable instructions may be provided in the form of one or more computer programs using any computer-readable media that is accessible by computing based device 600. Computer-readable media may include, for example, computer storage media such as memory 608 and communications media. Computer storage media, such as memory 608, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory 608) is shown within the computing-based device 600 it will be appreciated that the storage may be distributed or located remotely and accessed via a network or other communication link (e.g. using communication interface 610).

The computing-based device 600 also comprises an input/output controller 612 arranged to output display information to a display device 614 which may be separate from or integral to the computing-based device 600. The display information may provide a graphical user interface. The input/output controller 612 is also arranged to receive and process input from one or more devices, such as a user input device 616 (e.g. a mouse or a keyboard). This user input device 616 may be used to allow a user to enable or prevent release of secured data. In many embodiments the display device 614 may also act as the user input device 616 if it is a touch sensitive display device (e.g. using a finger or stylus). The input/output controller 612 may also output data to devices other than the display device, e.g. a locally connected printing device (not shown in FIG. 6).

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A method for controlling access to secured data stored on a mobile device, the method comprising:
receiving a request to release one or more data items associated with a user to a requesting application;
receiving one or more user inputs from the user, the one or more user inputs specifying if the one or more requested data items can be released; and
if a received user input specifies that a requested data item can be released, releasing the requested data item to the requesting application.

2. A method according to claim 1, wherein each data item comprises a credential associated with the user.

3. A method according to claim 1 further comprising:
receiving one or more data items at the mobile device; and
storing the one or more data items in a secure data store.

4. A method according to claim 3 wherein the secure data store is secured cryptographically and wherein storing the one or more data items in the secure data store comprises:
encrypting and storing the one or more data items in the secure data store.

5. A method according to claim 4 wherein encrypting and storing the one or more data items in the secure data store comprises:
encrypting the one or more data items using one or more of; asymmetric key encryption and symmetric key encryption; and
storing the encrypted one or more data items in the secure data store.

6. A method according to claim 3 wherein the data items are received from a trusted provisioning service.

7. A method according to claim 1, wherein the one or more user inputs received further comprise a verification of user identity.

8. A method according to claim 1 further comprising:
presenting an indication to a user as to whether a requested data item is considered essential.

9. A method according to claim 1 further comprising:
receiving an indication from the user that a particular data item may be supplied to a specified requesting party automatically; and
wherein upon receipt of a subsequent request from the specified requesting party for the particular data item, supplying the requested data item automatically.

10. A method according to claim 1 further comprising:
checking a certificate associated with the user each time access to one or more data items is requested.

11. A method according to claim 10 wherein, if on checking the certificate it is found to be invalid, access to all stored data items is revoked.

12. A tangible computer readable medium comprising computer program code to configure a computer to perform a method comprising:
receiving a request to release one or more data items associated with a user to a requesting application;
receiving one or more user inputs from the user, the one or more user inputs specifying if the one or more requested data items can be released; and
if a received user input specifies that a requested data item can be released, releasing the requested data item to the requesting application.

13. A mobile device arranged to control access to secured data, the mobile device comprising:
a secure data store arranged to store data items;
a user input device arranged to receive user inputs from a user;
requesting means arranged, in response to receiving a request from a requesting application to release one or more data items and one or more user inputs identifying which requested data items that can be released, to retrieve the identified data items from the secure data store and to supply the requested data items to the requesting application.

14. A mobile device according to claim 13, wherein each data item comprises a credential associated with the user.

15. A mobile device according to claim 13 further comprising:
provisioning means arranged to store data in the secure data store.

16. A mobile device according to claim 13 wherein the data stored in the secure data store is secured cryptographically.

17. A mobile device according to claim 16, wherein the data stored in the secure data store is secured using one or more of asymmetric key encryption and symmetric key encryption.

18. A mobile device according to claim 16, further comprising one or more of:
a software keystore arranged to store one or more encryption keys; and a hardware element arranged to store one or more encryption keys.

19. A mobile device according to claim 13 wherein the requesting application is an application executing on the mobile device or an application running on a device separate from the mobile device.

20. A mobile device according to claim 14 further comprising:
a trusted execution environment,
and wherein the requesting means, user input device and secure data store operate within the trusted execution environment and the requesting application operates outside the trusted execution environment.
